(19) United States
(12) Patent Application Publication
(10) Pub. No.: US 2009/0218403 A1
(43) Pub. Date: Sep. 3, 2009

(54) Arrangement for and method of accurately aiming at direct part markings prior to being imaged and electro-optically read

(76) Inventors: Eugene Joseph, Coram, NY (US); Rong Liu, Selden, NY (US)

Correspondence Address: MOTOROLA, INC., 1303 EAST ALGONQUIN ROAD, IL01/3RD, SCHAUMBURG, IL, 60196, US

(21) Appl. No.: 12/074,095

(22) Filed: Feb. 29, 2008

(51) Int. Cl. G06K 7/10

(52) U.S. Cl. 235/462.21

(57) ABSTRACT

Aiming of an imaging reader at direct part markings (DPM) on workpieces is enhanced by emitting an aiming light beam during aiming, and by optically modifying the aiming light beam during the aiming to generate an aiming light pattern having an outer bright region illuminated by the aiming light beam and visible to an operator to enable the operator to manually position the bright region to entirely surround at least part of the DPM, and an inner dark region not illuminated by the aiming light beam and surrounded by the bright region. The dark region contains the part of the DPM code to be imaged and read by the reader after the aiming.

### BACKGROUND OF THE INVENTION

Direct part marking (DPM) allows workpieces to be directly marked, identified and traced to their origin, and its use is growing in the automotive, aerospace, electronics, medical equipment, tooling, and metalworking industries, among many others. Despite the ability to control very tight specifications on element size, width, spacing and so on, the lack of sharp contrast of machine-readable optical DPM codes directly marked on metal, plastic, leather, glass, etc., workpieces prevents traditional moving laser beam readers from electro-optically reading the DPM codes reliably. These moving beam readers emit a laser beam, which reflects off the highly reflective, typically non-planar, metal or glass, workpieces as bright light.

To counter a variety of problems, such as lack of contrast, difficulty of maintaining precise element specifications, limited available marking areas, and a large amount of data to be encoded, the art proposed the use of matrix codes, especially the DataMatrix code, which reduces the required marking element size, precision and area, as well as contrast so that markings are able to be directly made on parts with, for example, steel or aluminum surfaces, and also proposed the use of imaging readers, for example, as disclosed in U.S. Pat. No. 7,201,321, which use solid-state arrays or imagers similar to those used in digital cameras to capture an image of the marking. A microprocessor is used to analyze and decode the captured image of the matrix code.

Yet, the use of imaging readers, especially handheld readers, for reading DPM codes on workpieces has proven to be challenging. Contrast is still often less than desirable. Ambient lighting conditions are variable. Illumination from on-board illuminators or illumination light sources is directed at variable angles. Reflections from ambient light sources and illumination light sources often appear in the field of view of the reader as hot spots, glare, or specular reflections of intense, bright light that saturate the imagers, thereby degrading reading performance.

In addition, aiming the handheld imaging readers at the DPM codes, prior to reading the DPM codes, has proven to be difficult. Requiring an operator to aim the reader at the DPM codes makes the process of locating and decoding the DPM codes faster and easier. Unlike machine-readable codes printed in one color (for example, black) on paper of another color (for example, white), DPM codes are typically difficult for a human operator to even find on the workpieces, which often have complicated, i.e., non-planar, curved, reflective surfaces, to further complicate finding the DPM codes and aiming the reader directly at the DPM codes for reading.

Further complicating the aiming process is that the DPM codes are relatively small, e.g., less than 2 mm×2 mm. It is generally known to generate an aiming pattern frame to help target a machine-readable code, such as a bar code symbol, prior to reading, but, in the case of DPM codes, the aiming pattern frame is also correspondingly small. Trying to target a small DPM code with a small aiming pattern frame on a curved, reflective surface is a time-consuming, laborious, operator-unfriendly procedure. Also, if the reader is brought close to the code, then the line of sight to the code may be obstructed.

### SUMMARY OF THE INVENTION

One feature of the present invention resides, briefly stated, in a method of, and an arrangement for, accurately aiming at indicia, especially direct part marking (DPM) codes on workpieces, prior to being imaged and electro-optically read. A light source, such as a laser, is operative for emitting an aiming light beam during aiming. An optical component is operative for optically modifying the aiming light beam during the aiming to generate an aiming light pattern having an outer bright region and an inner dim or dark region. The bright region is illuminated by the aiming light beam and is visible to an operator to enable the operator to manually position the bright region to entirely surround at least part, and preferably the entirety, of the DPM code. The dark region is not illuminated by the aiming light beam and is surrounded by the bright region. The dark region contains the part, and preferably the entirety, of the DPM code to be imaged and read after the aiming.

In a preferred embodiment, the bright region is circumferentially complete and symmetrical in all directions. Advantageously, the bright region is a circular annulus bounded by outer and inner concentric circles, and the dark region is an area contained within the inner circle. The DPM code occupies a predetermined area, e.g., less than 2 mm×2 mm, and the dark region has an area preferably greater than the predetermined area to contain the DPM code in its entirety.

In the preferred embodiment, the optical component may be a diffractive optical element (DOE), a refractive optical element (ROE), a holographic element, or a Fresnel element, which generates a light interference pattern. A non-interferometric optical component may also be used.

A handheld housing advantageously supports the light source and the optical component. A solid-state imager is also supported by the housing for capturing light over a field of view from the DPM code during subsequent imaging and reading. An illuminator may be used to illuminate the DPM code during the imaging and reading. A controller, e.g., a microprocessor, typically the same microprocessor used for decoding the DPM code, is operative for controlling that the aiming is not performed simultaneously with, and precedes, the imaging and the reading. The housing is aimed by the operator at a workpiece having the DPM code thereon.

Yet another feature of this invention resides in a method of accurately aiming at the direct part marking (DPM) code prior to being imaged and electro-optically read. The method is performed by emitting the aiming light beam during aiming; and by optically modifying the aiming light beam during the aiming to generate the aiming light pattern having the bright region illuminated by the aiming light beam and visible to an operator to enable the operator to manually position the bright region to entirely surround at least part, if not all, of the DPM code, and the dark region not illuminated by the aiming light beam and surrounded by the bright region, the dark region containing the part, if not all, of the DPM code to be imaged and read after the aiming.

Thus, the present invention proposes a large aiming pattern in which the outer bright region is highly visible to the operator. The annulus configuration is preferred, because it has no preference for orientation of the aiming pattern in any direction, e.g., up-and-down or side-to-side. The operator can easily and rapidly aim the bright region at, and position the bright region around, the DPM code and be reasonably assured that most, if not all, of the DPM code will be accurately located in the central dark region. The dark region is effectively a window for viewing the DPM code.

The novel features which are considered as characteristic of the invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a perspective view of a handheld imaging reader for electro-optically reading indicia by image capture and equipped with an arrangement for accurately aiming an aiming light pattern at indicia, such as a DPM code, in accordance with this invention;

FIG. 2 is a front elevational view on a reduced scale of the reader of FIG. 1;

FIG. 3 is a diagrammatic view of a reader analogous to that shown in FIG. 1, depicting various components thereof;

FIG. 4(a) is an enlarged view of an aiming light pattern generated in accordance with this invention on a DPM code of a small size;

FIG. 4(b) is an enlarged view of the aiming light pattern of FIG. 4(a) on a DPM code of a medium size; and

FIG. 4(c) is an enlarged view of the aiming light pattern of FIG. 4(a) on a DPM code of a large size.

### DETAILED DESCRIPTION OF THE PREFERRED EMBODIMENTS

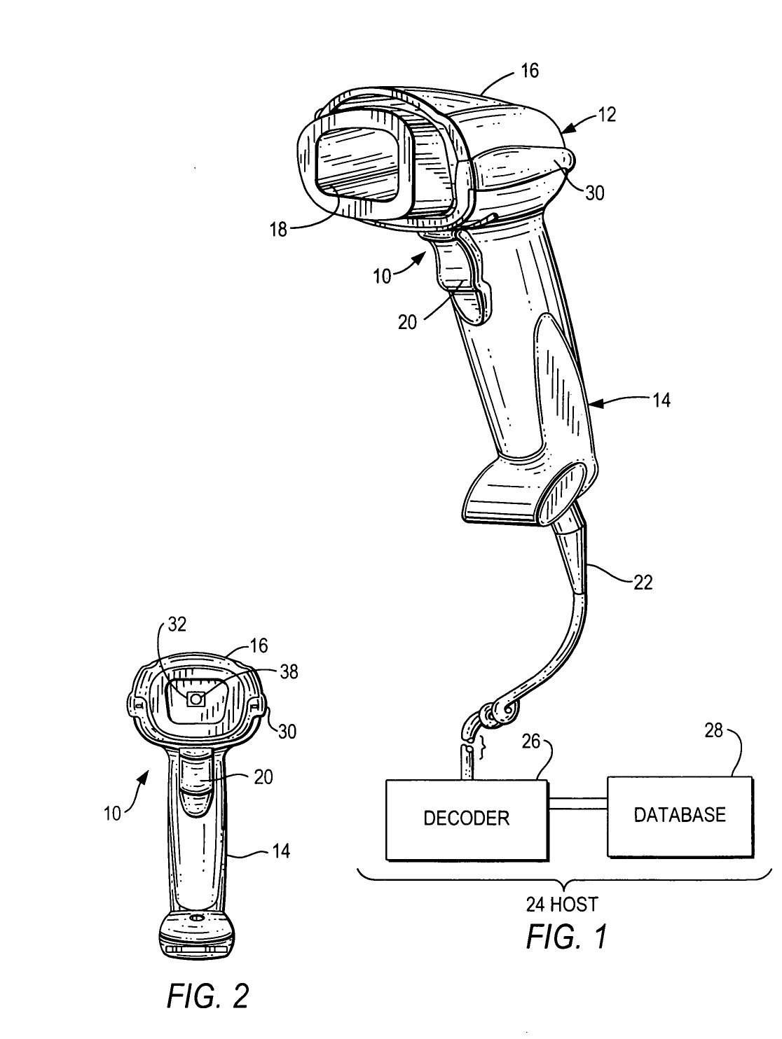

Reference numeral 10 in FIGS. 1-2 generally identifies a handheld, portable imaging reader for electro-optically reading indicia, such as DPM codes on workpieces. The reader 10 includes a housing 12 in which various aiming, illuminating, and image capture systems, as described below, are incorporated. The housing 12 includes a generally elongated handle or lower handgrip portion 14 and a barrel or upper body portion 16 having a front end region at which an open face 18 is located. The cross-sectional dimensions and overall size of the handle 14 are such that the reader can conveniently be held in an operator's hand. The body and handle portions may be constructed of a lightweight, resilient, shock-resistant, self-supporting material such as a synthetic plastic material. The plastic housing may be injection molded, but can be vacuum-formed or blow-molded to form a thin hollow shell which bounds an interior space whose volume is sufficient to contain the various systems of this invention. An overmold 30 of a resilient, shock-absorbing material, such as rubber, is exteriorly molded at various regions over the housing for shock protection.

A manually actuatable trigger 20 is mounted in a moving relationship on the handle 14 in a forward facing region of the reader. The operator's forefinger is normally used to actuate the reader by depressing the trigger. For example, the trigger may be depressed once to initiate aiming, and depressed again to initiate image capture and reading. Alternatively, aiming may be a default condition, and the trigger may be depressed just once to discontinue or change the default condition and to initiate image capture and reading. A flexible electrical cable 22 may be provided to connect the reader to remote components of the code reading system. In alternative embodiments, the cable may also provide electrical power to the systems within the reader. In preferred embodiments, the cable 22 is connected to a host 24 that receives decoded data from the reader. In alternative embodiments, a decode module 26 may be provided exteriorly to the reader. In such an embodiment, decoded data from the decode module 26 may be transmitted to further host processing equipment and databases represented generally by box 28. If the cable 22 is not used, then a wireless link to transfer data may be provided between the reader 10 and the host 24, and an on-board battery, typically within the handle, can be used to supply electrical power.

An alternative embodiment incorporates a display and a keyboard, and optionally a wireless transceiver, preferably with an on-board decoder. The decoded data is then either transferred to a remote host computer in real time, or saved to an internal memory such that the stored data can be transferred to a host computer at a later time in batch mode, when the reader is physically connected to such a connected host computer.

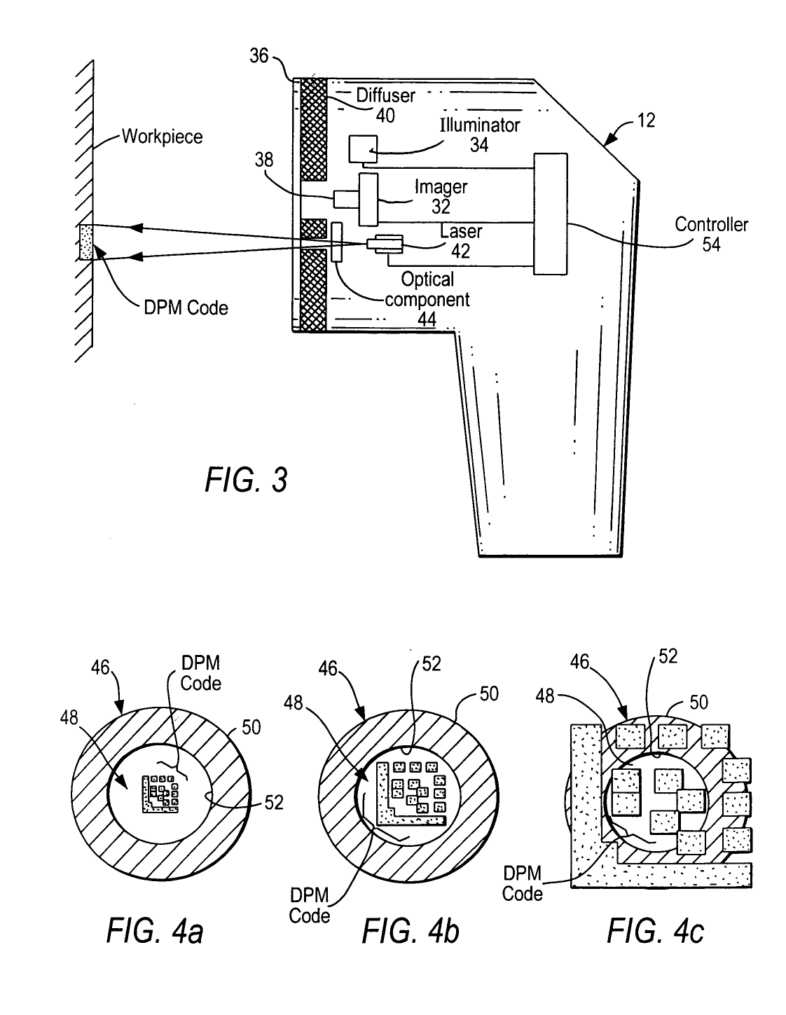

A solid-state imager 32, as shown in FIG. 3, is mounted within the housing 12 and preferably is a two-dimensional, charge coupled device (CCD) or a complementary metal oxide semiconductor (CMOS) array of cells or sensors operative for capturing light over its field of view from the DPM code through a light-transmissive window 36 to seal the housing from entry of contaminants, and through an imaging lens assembly 38 for delivery to the sensors. The sensors produce electrical signals corresponding to a two-dimensional array of pixel information for an image of the DPM code. The imager 32 and lens assembly 38 are preferably aligned along a centerline or an optical axis generally centrally located within the body portion 16.

The lens assembly 38 has a fixed or variable focus and enables image capture over a range of working distances between a close-in distance and a far-out distance relative to the window 36. The imager and lens assembly are capable of acquiring a full image of the DPM code in lighting conditions from two lux to direct sunlight. Exposure time is about 15 milliseconds, and the imager is actuated, preferably once every 200-300 milliseconds. Resolution of the array can be of various sizes, although megapixel resolution is preferred.

An illuminator 34 is provided to provide an illumination field for the imager 32. The illuminator preferably constitutes a single illumination light source, or a plurality of illumination light sources, e.g., red light emitting diodes (LEDs), energized by power supply lines in the cable 22, or via the on-board battery. A diffuser 40 is operative for diffusing the illumination light en route to the DPM code. The diffuser 40 minimizes hot spots, glare and specular reflections and renders the illumination light more uniform across the DPM code. The diffuser 40, preferably a translucent or textured member, scatters the illumination light emitted by the illuminator 34.

In accordance with one feature of this invention, an aiming light source, such as a laser 42, is operative for emitting an aiming light beam, preferably in the red spectrum, during aiming. An optical component 44 is operative for optically modifying the aiming light beam during the aiming to generate an aiming light pattern having, as best seen in FIGS. 4(a)-(c), an outer bright region 46 and an inner dark region 48. The bright region 46 is illuminated by the aiming light beam and is visible to an operator to enable the operator to manually position the bright region 46 to entirely surround at least part, and preferably the entirety, of the DPM code. The inner or central dark region 48 is not illuminated by the aiming light beam and is surrounded by the bright region 46. The dark region 48 contains the part, and preferably the entirety, of the DPM code to be imaged and read after the aiming.

In a preferred embodiment, the bright region 46 is circumferentially complete and symmetrical in all directions. Advantageously, the bright region 46 is a circular annulus bounded by outer 50 and inner 52 concentric circles, and the dark region 48 is an area contained within the inner circle 52. The DPM code occupies a predetermined area, e.g., less than 2 mm×2 mm. As shown in FIG. 4(a), the dark region 48 has an area much greater than the predetermined area to contain a DPM code of relatively small size in its entirety. As shown in FIG. 4(b), the dark region 48 has an area slightly greater than the predetermined area to contain a DPM code of relatively medium size in its entirety. As shown in FIG. 4(c), the dark region 48 has an area smaller than the predetermined area to contain only a part of a DPM code of relatively large size.

In the preferred embodiment, the optical component 44 may be a diffractive optical element (DOE), a refractive optical element (ROE), a holographic element, or a Fresnel element, which generates a light interference pattern. A non-interferometric optical component may also be used.

In use, once the trigger 20 is depressed, a controller or microprocessor 54, preferably the same microprocessor used to decode and read the DPM code, actuates the aiming laser 42 to generate an aiming laser beam that diverges until it passes through an aperture stop (not illustrated), in which the beam is optically modified to have a predetermined cross-section. Alternatively, the aiming laser beam may be generated prior to depression of the trigger, and preferably pulsed, for example at a 50% duty cycle, whereupon, after the trigger 20 has been depressed, the controller 54 is operative to change the duty cycle. Thereupon, the aiming laser beam passes through the optical component 44, in which the beam is focused, collimated, and optically modified to generate the large aiming light pattern having the outer bright region 46 and the inner dark region 48, as described above.

The bright region 46 is highly visible to the operator. The annulus configuration is preferred, because it has no preference for orientation of the aiming pattern in any direction, e.g., up-and-down or side-to-side. The operator can easily and rapidly aim the bright region 46 at, and position the bright region 46 around, the DPM code and be reasonably assured that the DPM code will be accurately located in the central dark region 48. The dark region 48 is effectively a window for viewing the DPM code.

After aiming, the controller 54 deactuates the aiming laser and stops generating the aiming light pattern, and then actuates the illuminator 34 and the imager 32 to initiate imaging and reading of the DPM code. When the DPM code is entirely in the dark region 48, a successful read is more likely as compared to when only a part of the DPM code is located therein.

It will be understood that each of the elements described above, or two or more together, also may find a useful application in other types of constructions differing from the types described above. For example, other aiming light patterns, such as polygonal patterns, are contemplated. Also, it may be desired to generate a central aiming spot or mark as part of the aiming light pattern. In this case, the spot would advantageously be centered in the dark region 48 to indicate the center of the DPM code.

While the invention has been illustrated and described as embodied in an aiming arrangement and method used in an imaging reader for electro-optically reading DPM codes, it is not intended to be limited to the details shown, since various modifications and structural changes may be made without departing in any way from the spirit of the present invention. For example, to prevent the red illumination LEDs from washing out the red aiming light pattern, the imager is actuated infrequently, for example, once every 200-300 milliseconds as noted above, rather than having the imager be free-running.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention and, therefore, such adaptations should and are intended to be comprehended within the meaning and range of equivalence of the following claims.

We claim:

1. An arrangement for aiming at a direct part marking (DPM) code prior to being imaged and electro-optically read, comprising:
a light source for emitting an aiming light beam during aiming; and
an optical component for optically modifying the aiming light beam during the aiming to generate an aiming light pattern having a bright region illuminated by the aiming light beam and visible to an operator to enable the operator to manually position the bright region to entirely surround at least part of the DPM code, and a dark region not illuminated by the aiming light beam and surrounded by the bright region, the dark region containing the part of the DPM code to be imaged and read after the aiming.

2. The arrangement of claim 1, wherein the bright region is circumferentially complete and symmetrical.

3. The arrangement of claim 1, wherein the bright region is a circular annulus bounded by outer and inner concentric circles, and wherein the dark region is an area contained within the inner circle.

4. The arrangement of claim 1, wherein the light source is a laser.

5. The arrangement of claim 1, wherein the optical component is one of a diffractive optical element and a refractive optical element.

6. The arrangement of claim 1, wherein the DPM code occupies a predetermined area, and wherein the dark region has an area greater than the predetermined area to contain the DPM code in its entirety.

7. The arrangement of claim 1, and further comprising a handheld housing by which the light source and the optical component are supported and aimed by the operator at a workpiece having the DPM code thereon.

8. The arrangement of claim 1, and further comprising a controller for controlling that the aiming is not performed simultaneously with the imaging and the reading.

9. An arrangement for aiming at a direct part marking (DPM) code prior to being imaged and electro-optically read, comprising:
means for emitting an aiming light beam during aiming; and
means for optically modifying the aiming light beam during the aiming to generate an aiming light pattern having a bright region illuminated by the aiming light beam and visible to an operator to enable the operator to manually position the bright region to entirely surround at least part of the DPM code, and a dark region not illuminated by the aiming light beam and surrounded by the bright region, the dark region containing the part of the DPM code to be imaged and read after the aiming.

10. The arrangement of claim 9, wherein the bright region is circumferentially complete and symmetrical.

11. The arrangement of claim 9, wherein the bright region is a circular annulus bounded by outer and inner concentric circles, and wherein the dark region is an area contained within the inner circle.

12. A method of aiming at a direct part marking (DPM) code prior to being imaged and electro-optically read, comprising the steps of:
emitting an aiming light beam during aiming; and
optically modifying the aiming light beam during the aiming to generate an aiming light pattern having a bright region illuminated by the aiming light beam and visible to an operator to enable the operator to manually position the bright region to entirely surround at least part of the DPM code, and a dark region not illuminated by the aiming light beam and surrounded by the bright region, the dark region containing the part of the DPM code to be imaged and read after the aiming.

13. The method of claim 12, and the step of configuring the bright region to be circumferentially complete and symmetrical.

14. The method of claim 12, and the step of configuring the bright region to be a circular annulus bounded by outer and inner concentric circles, and the step of configuring the dark region to be an area contained within the inner circle.

15. The method of claim 12, wherein the emitting step is performed by a laser.

16. The method of claim 12, wherein the optically modifying step is performed by one of a diffractive optical element and a refractive optical element.

17. The method of claim 12, and the step of configuring the DPM code to occupy a predetermined area, and the step of configuring the dark region to have an area greater than the predetermined area to contain the DPM code in its entirety.

18. The method of claim 12, wherein the emitting step and the optically modifying step are performed with a handheld housing supported by the operator, and the step of aiming the housing at a workpiece having the DPM code thereon.

19. The method of claim 12, and the step of controlling the aiming to be not performed simultaneously with the imaging and the reading.
